(19) United States
(12) Patent Application Publication
(10) Pub. No.: US 2025/0262869 A1
(43) Pub. Date: Aug. 21, 2025

(54) INKJET PRINTING DEVICE

(71) Applicant: VEEGOO TECHNOLOGY CO., LTD., Foshan (CN)

(72) Inventors: Yeheng QIU, Foshan (CN); Jianqing DENG, Foshan (CN); Zhenjie LI, Foshan (CN)

(21) Appl. No.: 19/060,854

(22) Filed: Feb. 24, 2025

Related U.S. Application Data
(63) Continuation of application No. PCT/CN2025/078006, filed on Feb. 19, 2025.

(30) Foreign Application Priority Data
May 14, 2024 (CN) 202421049791.2

(51) Int. Cl. B41J 3/28; B41J 2/175; B41J 3/54; B41J 13/08; B41J 25/00; B41J 25/308; B41J 29/02; B41J 29/393

(52) U.S. Cl. CPC B41J 3/28; B41J 2/17503; B41J 2/17596; B41J 3/543; B41J 13/08; B41J 25/001; B41J 25/308; B41J 29/02; B41J 29/393

(57) ABSTRACT

An inkjet printing device, including a conveying mechanism, an inkjet assembly, a moving mechanism, a frame and an electronic control unit. The frame is provided with a processing zone. The conveying mechanism includes a transmission belt, a transmission roller and a driving part. The transmission belt is configured to receive and convey a panel. The driving part is configured to drive the transmission roller to rotate, so as to drive the transmission belt to convey the panel to the processing zone. A positioning plate is provided adjacent to the processing zone, and the positioning plate is provided with a pressure sensor to detect contact between the panel and the positioning plate. The moving mechanism is configured to drive the inkjet assembly to reciprocate linearly above the processing zone. The inkjet assembly is configured to spray ink onto the panel in the processing zone.

### CROSS-REFERENCE TO RELATED APPLICATIONS

This application is a continuation of International Patent Application No. PCT/CN2025/078006, filed on Feb. 19, 2025, which claims the benefit of priority from Chinese Patent Application No. 202421049791.2, filed on May 14, 2024. The content of the aforementioned application, including any intervening amendments thereto, is incorporated herein by reference in its entirety.

### TECHNICAL FIELD

This application relates to printers, and more particularly to an inkjet printing device.

### BACKGROUND

Inkjet printing technology has been widely applied across various industries, particularly in the field of panel inkjet printing. Regarding the existing inkjet printers, a driving mechanism is required to move a panel-carrying platform to a predetermined position, and then the panel is subjected to inkjet printing. This process requires an additional operating platform, and often results in inaccurate positioning. Positional deviations may occur during the panel transfer process, causing the panel's centerline to be non-parallel with a panel transport direction. Therefore, there is an urgent need for a printer with simplified structure, reduced cost, improved positioning accuracy and enhanced printing quality to meet the demands for panel customization.

### SUMMARY

In view of this, an object of the disclosure is to provide an inkjet printing device with simplified processing platform and improved pane positioning precision.

Technical solutions of the present disclosure are described as follows.

An inkjet printing device, comprising:
a conveying mechanism;
an inkjet assembly;
a moving mechanism;
a frame; and
an electronic control unit;
wherein the frame is provided with a processing zone; and the conveying mechanism and the moving mechanism are mounted on the frame;
the conveying mechanism comprises a transmission belt, a transmission roller and a first driving part;
the transmission belt is configured to receive and convey a to-be-printed panel; the first driving part is configured to drive the transmission roller to rotate, so as to drive the transmission belt to convey the to-be-printed panel to the processing zone; a positioning plate is provided adjacent to the processing zone; and the positioning plate is provided with at least one pressure sensor configured to detect whether the to-be-printed panel abuts against the positioning plate;
the moving mechanism is configured to drive the inkjet assembly to reciprocate linearly above the processing zone;
the inkjet assembly is configured to spray an ink material onto the to-be-printed panel in the processing zone; and
the electronic control unit is electrically connected to the conveying mechanism, the inkjet assembly, the moving mechanism and the at least one pressure sensor.

In some embodiments, the positioning plate is a baffle extending across the transmission belt; a length direction of the baffle is perpendicular to a transport direction of the transmission belt; and the number of the at least one pressure sensor is at least two, and at least two pressure sensors are symmetrically distributed on the baffle; or
the positioning plate is composed of two stop blocks arranged detachably and opposite to each other; the two stop blocks are respectively provided above two sides of the transmission belt; and a distance between the two stop blocks is dependent on lengths of the two stop blocks, and the distance is less than a width of the to-be-printed panel.

In some embodiments, the frame is provided with an idle zone, and the idle zone is provided on a side of the processing zone; the moving mechanism is configured to drive the inkjet assembly to reciprocate linearly above the processing zone and the idle zone; and the inkjet assembly is provided in the idle zone in response to a case that the inkjet assembly is not in operation.

In some embodiments, the frame is provided with an ink receiving portion, and the ink receiving portion is provided below the idle zone; two sides of the ink receiving portion are configured to be trapezoidal; a splash-proof strip is provided at an opening of the ink receiving portion; and an area of the opening of the ink receiving portion is greater than an area of the idle zone.

In some embodiments, the conveying mechanism further comprises a support strip provided within the transmission belt; and the support strip is configured to support a panel-receiving surface of the transmission belt.

In some embodiments, the moving mechanism comprises an X-axis slide rail, a second driving part, a Y-axis slide rail, a third driving part, a Z-axis slide rail and a fourth driving part;
two sides of the frame are each provided with the X-axis slide rail;
the Z-axis slide rail is slidably mounted on the X-axis slide rail; and the second driving part is configured to drive the Z-axis slide rail to move along an X-axis direction;
the Y-axis slide rail is slidably mounted on the Z-axis slide rail; and the fourth driving part is configured to drive the Y-axis slide rail to move along a Z-axis direction; and
the inkjet assembly is slidably mounted on the Y-axis slide rail; and the third driving part is configured to drive the inkjet assembly to move along a Y-axis direction.

In some embodiments, the inkjet assembly comprises a first inkjet head and a first ink cartridge; the first ink cartridge is mounted on an outer side of the frame; and the first inkjet head is configured to draw the ink material from the first ink cartridge through a first suction pump and spray the ink material onto the to-be-printed panel.

In some embodiments, the inkjet assembly further comprises a second inkjet head and a second ink cartridge; and the second inkjet head is configured to draw the ink material from the second ink cartridge through a second suction pump and spray the ink material onto the to-be-printed panel.

In some embodiments, the frame is provided with a plurality of horizontal beams and a plurality of vertical beams; and the plurality of horizontal beams and the plurality of vertical beams are provided at a bottom of an overall structure of the X-axis slide rail, the Y-axis slide rail and the Z-axis slide rail, so as to support the conveying mechanism, the inkjet assembly and the moving mechanism.

In some embodiments, the frame further comprises two fixing slots; one of the two fixing slots is connected to one of the plurality of vertical beams at the bottom of the X-axis slide rail, and the other of the two fixing slots is connected to the Z-axis slide rail; and the two fixing slots are each provided with a drag chain slot fitting a corresponding one of the two fixing slots.

Compared to the prior art, the present disclosure has the following beneficial effects.

Regarding the inkjet printing device provided herein, a to-be-printed panel is conveyed to the processing zone through the transmission belt; the pressure sensor is configured to position the to-be-printed panel, and can also effectively prevent the to-be-printed panel from tilting before the inkjet assembly operates; and then the inkjet assembly is activated to complete the ink spraying on the to-be-printed panel, thereby achieving automated production, improving production efficiency and the continuity of the production system, and further ensuring the printing quality of the panel and the stability of the finished product.

### BRIEF DESCRIPTION OF THE DRAWINGS

FIG. 1 schematically shows an inkjet printing device according to an embodiment of the present disclosure;

FIG. 2 schematically shows the inkjet printing device according to another embodiment of the present disclosure;

FIG. 3 schematically shows an ink receiving portion according to an embodiment of the present disclosure;

FIG. 4 is a bottom view of FIG. 1 or FIG. 2; and

FIG. 5 schematically shows a bottom portion of FIG. 1 or FIG. 2 (without the ink receiving portion).

In the figures: 1-conveying mechanism; 11-transmission belt; 12-transmission roller; 13-first driving part; 14-support strip; 2-inkjet assembly; 21-first inkjet head; 22-first ink cartridge; 23-second inkjet head; 24-second ink cartridge; 3-moving mechanism; 31-X-axis slide rail; 311-second driving part; 32-Y-axis slide rail; 322-third driving part; 33-Z-axis slide rail; 333-fourth driving part; 4-processing zone; 41-positioning plate; 5-idle zone; 51-ink receiving portion; 511-splash-proof strip; 6-frame; 61-fixing slot; and 62-drag chain slot.

### DETAILED DESCRIPTION OF EMBODIMENTS

The embodiments of the present disclosure are described in detail below. The exemplary embodiments are illustrated in the accompanying drawings, in which the same or similar reference numerals indicate the same or similar elements or elements having the same or similar functions throughout the drawings. The embodiments described with reference to the accompanying drawings are merely exemplary and illustrative, and are not intended to limit the disclosure.

In the description of the present disclosure, it should be understood that, the orientation or positional relationships terms, such as “up”, “down”, “front”, “back”, “left”, “right”, “top”, “bottom”, “inner” and “outer” are based on those shown in the accompanying drawings. These terms are solely for the convenience of describing the present disclosure in a simplified manner, and are not intended to indicate or imply that the devices or components must have specific orientations or be constructed and operated in such orientations. Therefore, these terms should not be understood as limitations of the present disclosure.

As used herein, terms such as “first”, “second” and “third” are only descriptive, and should not be construed as indicating or implying their relative importance or implicitly specifying the number of technical features indicated. As a result, a feature defined as “first”, “second” or “third” may include one or more of such features, either explicitly or implicitly.

It should be noted that, unless otherwise expressly specified or limited, the terms “mounted”, “connected” and “coupled” are to be interpreted in a broad sense. For example, a connection can be a fixed connection, a detachable connection, an integral connection. It can be a mechanical connection, an electrical connection, a direct connection, or it can be an indirect connection achieved through an intermediary medium. Additionally, it can refer to an internal communication between two components. The specific meaning of these terms in the present disclosure can be understood by those skilled in the art based on the particular circumstances.

The technical solutions of the present disclosure will be described in further detail below with reference to the accompanying drawings and embodiments.

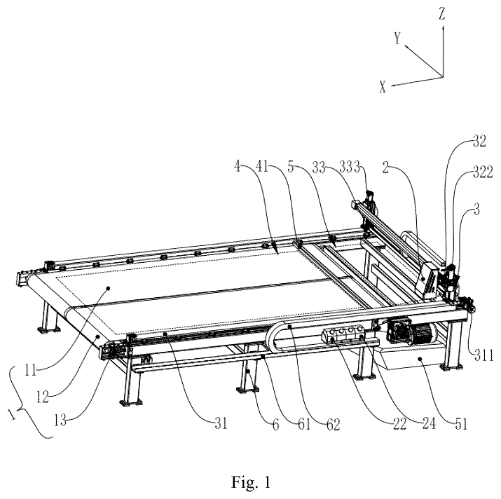

As shown in FIGS. 1-5, an embodiment of the present disclosure provides an inkjet printing device, including a conveying mechanism 1, an inkjet assembly 2, a moving mechanism 3, a frame 6 and an electronic control unit. The frame 6 is provided with a processing zone 4. The conveying mechanism 1 and the moving mechanism 3 are mounted on the frame 6. The conveying mechanism 1 includes a transmission belt 11, a transmission roller 12 and a first driving part 13. The transmission belt 11 is configured to receive and convey a to-be-printed panel. The first driving part 13 is configured to drive the transmission roller 12 to rotate, so as to drive the transmission belt 11 to convey the to-be-printed panel to the processing zone 4. A positioning plate 41 is provided adjacent to the processing zone 4. The positioning plate 41 is provided with at least one pressure sensor configured to detect whether the to-be-printed panel abuts against the positioning plate 41. The moving mechanism 3 is configured to drive the inkjet assembly 2 to reciprocate linearly above the processing zone 4. The inkjet assembly 2 is configured to spray an ink material onto the to-be-printed panel in the processing zone 4. The electronic control unit is electrically connected to the conveying mechanism 1, the inkjet assembly 2, the moving mechanism 3 and the at least one pressure sensor.

Specifically, the electronic control unit is electrically connected to the conveying mechanism 1, the inkjet assembly 2, the moving mechanism 3 and the at least one pressure sensor, so as to control the inkjet printing device. In particular, the to-be-printed panel is placed on the transmission belt 11 by a machine. The first driving part 13 is configured to drive the transmission roller 12 to rotate, thereby driving the transmission belt 11 to convey the to-be-printed panel to the processing zone 4. Meanwhile, the pressure sensor is horizontally mounted on the positioning plate 41 to detect whether the to-be-printed panel conveys into place. When the to-be-printed panel reaches the positioning plate 41 adjacent to the processing zone 4, the to-be-printed panel exerts a force on the positioning plate 41. The pressure sensor on the positioning plate 41 detects the presence of pressure, indicating that the to-be-printed panel is accurately positioned. Once the to-be-printed panel has been accurately positioned, the first driving part 13 stops operating, such that the transmission belt 11 is stopped. Subsequently, the moving mechanism 3 drives the inkjet assembly 2 to reciprocate linearly above the processing zone 4, and the inkjet assembly 2 sprays an ink material onto the panel which has been accurately positioned on the transmission belt 11 according to preset parameters, thereby completing the inkjet printing of the to-be-printed panel.

In this embodiment, the first driving part 13 is a motor or a pneumatic cylinder. However, in some embodiments, it can be any other type of driving device. The number of transmission belts 11 is two, which allows the load of the to-be-printed panel to be evenly distributed across the two transmission belts 11, helping to reduce the load pressure on a single transmission belt 11, thereby extending the service life of the transmission belts 11.

In summary, regarding the inkjet printing device provided herein, the to-be-printed panel is conveyed to the processing zone through the transmission belt 11; the pressure sensor is configured to position the to-be-printed panel, and can also effectively prevent the to-be-printed panel from tilting before the inkjet assembly 2 operates; and then the inkjet assembly 2 is activated to complete the ink spraying on the to-be-printed panel, thereby achieving automated production, improving production efficiency and the continuity of the production system, and further ensuring the printing quality of the panel and the stability of the finished product.

In some embodiments, the positioning plate 41 is a baffle extending across the transmission belt 11. A length direction of the baffle is perpendicular to a transport direction of the transmission belt 11. The number of the at least one pressure sensor is at least two, and at least two pressure sensors are symmetrically distributed on the baffle. Alternatively, the positioning plate 41 is composed of two stop blocks arranged detachably and opposite to each other. The two stop blocks are respectively provided above two sides of the transmission belt 11. A distance between the two stop blocks is dependent on lengths of the two stop blocks, and the distance is less than a width of the to-be-printed panel.

In an embodiment, as shown in FIG. 1, the positioning plate 41 is the baffle extending across the transmission belt 11. The number of the at least one pressure sensor is at least two, and at least two pressure sensors are symmetrically distributed on the baffle. When the to-be-printed panel presses against the pressure sensors symmetrically distributed on the baffle, the to-be-printed panel is in an accurately positioned state, and the inkjet assembly 2 completes the ink spraying on the to-be-printed panel. With the pressure sensors symmetrically distributed, when two pressure sensors detect the to-be-printed panel simultaneously, it can be confirmed that a centerline of the to-be-printed panel is parallel to a transport direction of the to-be-printed panel, that is, the to-be-printed panel has not shifted on the transmission belt 11.

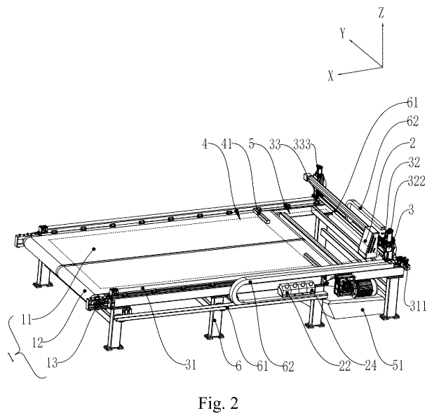

In an embodiment, as shown in FIG. 2, the positioning plate 41 is composed of two stop blocks arranged detachably and opposite to each other. The two stop blocks can be replaced with different lengths according to a size of the to-be-printed panel. The distance between the two stop blocks is less than the width of the to-be-printed panel. A front end of each of the two stop blocks in a horizontal direction is provided with the pressure sensor. And the pressure sensor is configured to simultaneously detect whether the panel correctly positions during its transport to ensure more accurate positioning.

In some embodiments, the frame 6 is provided with an idle zone 5, and the idle zone 5 is provided on a side of the processing zone 4. The moving mechanism 3 is configured to drive the inkjet assembly 2 to reciprocate linearly above the processing zone 4 and the idle zone 5. And the inkjet assembly 2 is provided in the idle zone 5 in response to a case that the inkjet assembly 2 is not in operation.

As shown in FIG. 1 or FIG. 2, the idle zone 5 is configured to prevent residual ink in the inkjet assembly 2 from contaminating the panel. During an initial activation of the inkjet assembly 2, the idle zone 5 prevents instability in the initial velocity, thereby avoiding the risk of the residual ink from a previous inkjet operation dropping and contaminating the transmission belt 11 or the to-be-printed panel.

In some embodiments, the frame 6 is provided with an ink receiving portion 51, and the ink receiving portion 51 is provided below the idle zone 5. Two sides of the ink receiving portion 51 are configured to be trapezoidal. A splash-proof strip 511 is provided at an opening of the ink receiving portion 51. And an area of the opening of the ink receiving portion 51 is greater than an area of the idle zone 5.

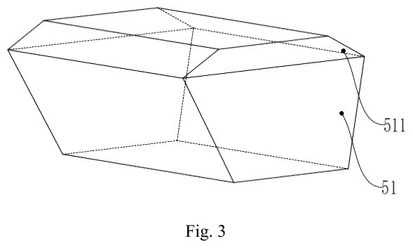

As shown in FIG. 3, the two sides of the ink receiving portion 51 have a trapezoidal structure with an inclined angle. When residual ink drips down, it flows along the inclined surface of the trapezoidal structure and falls into an interior of the ink receiving portion 51. The design of the trapezoidal structure and the splash-proof strip 511 is intended to prevent residual ink from splashing and contaminating the inkjet printing device. Additionally, the area of the opening of the ink receiving portion 51 is greater than the area of the idle zone 5 to prevent ink from falling directly onto the ground, making it inconvenient to clean.

In some embodiments, the conveying mechanism 1 further includes a support strip 14 provided within the transmission belt 11. And the support strip 14 is configured to support a panel-receiving surface of the transmission belt 11.

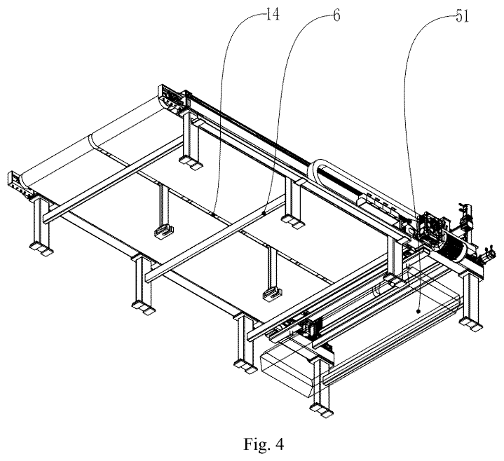

As shown in FIG. 4, the support strip 14 is provided in plurality, and a plurality of support strips 14 are uniformly distributed between a top surface and a bottom surface of the transmission belt 11. By means of this arrangement, a load pressure on the transmission belt 11 is effectively reduced, enabling stable support of the to-be-printed panel in the processing zone 4 and facilitating improved spraying processes for the to-be-printed panel.

In some embodiments, the moving mechanism 3 includes an X-axis slide rail 31, a second driving part 311, a Y-axis slide rail 32, a third driving part 322, a Z-axis slide rail 33 and a fourth driving part 333. Two sides of the frame 6 are each provided with the X-axis slide rail 31. The Z-axis slide rail 33 is slidably mounted on the X-axis slide rail 31. The second driving part 311 is configured to drive the Z-axis slide rail 33 to move along an X-axis direction. The Y-axis slide rail 32 is slidably mounted on the Z-axis slide rail 33. The fourth driving part 333 is configured to drive the Y-axis slide rail 32 to move along a Z-axis direction. The inkjet assembly 2 is slidably mounted on the Y-axis slide rail 32. And the third driving part 322 is configured to drive the inkjet assembly 2 to move along a Y-axis direction.

As shown in FIG. 1 or FIG. 2, the moving mechanism 3 is configured to drive the inkjet assembly 2 to reciprocate linearly in the X-axis, Y-axis, and Z-axis directions. The movement along the above three axes enables precise control in three directions, allowing the inkjet printing device to perform accurate printing on panels of different shapes and sizes, thereby improving printing quality and product stability. Specifically, the third driving part 322 is configured to drive the inkjet assembly 2 to move along the Y-axis slide rail 32. The fourth driving part 333 is configured to drive the Y-axis slide rail 32 and the inkjet assembly 2 to move along the Z-axis slide rail 33. The second driving part 311 is configured to drive the Z-axis slide rail 33, the Y-axis slide rail 32 and the inkjet assembly 2 to move along the X-axis slide rail 31, thereby enabling the moving mechanism 3 to drive the inkjet assembly 2 to reciprocate linearly in the X-axis, Y-axis, and Z-axis directions.

In some embodiments, the X-axis slide rails 31 are arranged in parallel on the two sides of the frame 6. Each of the two X-axis slide rails 31 is slidably provided with the Z-axis slide rail 33. Two Z-axis slide rails 33 are parallel to each other, and the Y-axis slide rail 32 is slidably connected between the two Z-axis slide rails 33, thereby forming a stable linear motion slide rail structure. In this embodiment, the second driving part 311, the third driving part 322 and the fourth driving part 333 are motors or pneumatic cylinders. However, in some embodiments, the second driving part 311, the third driving part 322 and the fourth driving part 333 can be other types of driving devices.

In some embodiments, the inkjet assembly 2 includes a first inkjet head 21 and a first ink cartridge 22. The first ink cartridge 22 is mounted on an outer side of the frame 6. And the first inkjet head 21 is configured to draw the ink material from the first ink cartridge 22 through a first suction pump and spray the ink material onto the to-be-printed panel.

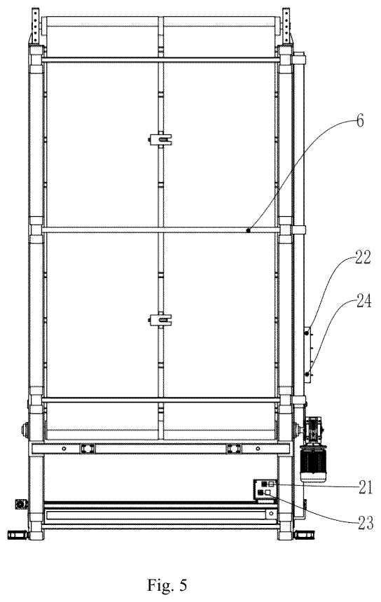

As shown in FIG. 5, a purpose of such a configuration is to draw the ink material from the first ink cartridge 22 mounted on the outer side of the frame 6 by using the first suction pump. This design simplifies and accelerates ink replacement, thereby improving production efficiency and enhancing the practicality of the inkjet printing device. Additionally, the first suction pump can adjust an ink ejection pressure as needed to accommodate different types of panels and printing requirements.

In some embodiments, the inkjet assembly 2 further includes a second inkjet head 23 and a second ink cartridge 24. And the second inkjet head 23 is configured to draw the ink material from the second ink cartridge 24 through a second suction pump and spray the ink material onto the to-be-printed panel.

As shown in FIG. 5, specifically, when the ink is depleted, the ink material in the second ink cartridge 24 can be drawn into the second inkjet head 23 through the second suction pump, thereby continuing the spraying process on the panel. Such a design eliminates the need to shut down the inkjet printing device for refilling and restarting, ensuring continuous operation without interrupting the ink refilling process.

In some embodiments, the frame 6 is provided with a plurality of horizontal beams and a plurality of vertical beams. And the plurality of horizontal beams and the plurality of vertical beams are provided at a bottom of an overall structure of the X-axis slide rail 31, the Y-axis slide rail 32 and the Z-axis slide rail 33, so as to support the conveying mechanism 1, the inkjet assembly 2 and the moving mechanism 3.

Specifically, the plurality of horizontal beams and the plurality of vertical beams are provided at the bottom of the overall structure of the X-axis slide rail 31, the Y-axis slide rail 32 and the Z-axis slide rail 33. Two of the plurality of horizontal beams are respectively mounted at the bottom of the X-axis slide rail 31, and those of the plurality of vertical beams arranged in parallel and uniformly spaced are connected between the two horizontal beams and the ground for support. A horizontal beam configured to stabilize the structure is connected between two opposite vertical beams. The plurality of vertical beams are also provided at a connection between the support strip 14 and the ground. A design of the plurality of horizontal beams and the plurality of vertical beams forms a stable support structure combining the conveying mechanism 1, the inkjet assembly 2 and the moving mechanism 3. The horizontal beam connected between the two vertical beams is spaced from the transmission belt 11, ensuring that it does not interfere with the transmission of the to-be-printed panel by the transmission belt 11.

In some embodiments, the frame further includes two fixing slots 61. One of the two fixing slots 61 is connected to one of the plurality of vertical beams at the bottom of the X-axis slide rail 31, and the other of the two fixing slots 61 is connected to the Z-axis slide rail 33. And the two fixing slots 61 are each provided with a drag chain slot 62 fitting a corresponding one of the two fixing slot 61.

As shown in FIG. 1 or FIG. 2, one of the two fixing slots 61 is connected to the Z-axis slide rail 33, such that one of the two fixing slots 61 and the Z-axis slide rail 33 are positioned in the same plane to enable synchronous movement, thereby reinforcing and stabilizing the movement of the Y-axis slide rail 32 and the inkjet assembly 2 along the X-axis slide rail 31. The two fixing slots 61 are each provided with the drag chain slot 62 fitting a corresponding one of the two fixing slots 61. The drag chain slot 62 is configured to accommodate a wiring assembly, preventing the wiring assembly from affecting the movement of the moving mechanism 3. The other of the two fixing slots 61 is connected to the plurality of vertical beams at the bottom of the X-axis slide rail 31 and the drag chain slot 62, further enhancing the overall stability and safety of the frame 6.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An inkjet printing device, comprising:
a conveying mechanism;
an inkjet assembly;
a moving mechanism;
a frame; and
an electronic control unit;
wherein the frame is provided with a processing zone; and the conveying mechanism and the moving mechanism are mounted on the frame;
the conveying mechanism comprises a transmission belt, a transmission roller and a first driving part;
the transmission belt is configured to receive and convey a to-be-printed panel; the first driving part is configured to drive the transmission roller to rotate, so as to drive the transmission belt to convey the to-be-printed panel to the processing zone; a positioning plate is provided adjacent to the processing zone; and the positioning plate is provided with at least one pressure sensor configured to detect whether the to-be-printed panel abuts against the positioning plate;
the moving mechanism is configured to drive the inkjet assembly to reciprocate linearly above the processing zone;
the inkjet assembly is configured to spray an ink material onto the to-be-printed panel in the processing zone; and
the electronic control unit is electrically connected to the conveying mechanism, the inkjet assembly, the moving mechanism and the at least one pressure sensor.

2. The inkjet printing device according to claim 1, wherein the positioning plate is a baffle extending across the transmission belt; a length direction of the baffle is perpendicular to a transport direction of the transmission belt; and the number of the at least one pressure sensor is at least two, and at least two pressure sensors are symmetrically distributed on the baffle; or
the positioning plate is composed of two stop blocks arranged detachably and opposite to each other; the two stop blocks are respectively provided above two sides of the transmission belt; and a distance between the two stop blocks is dependent on lengths of the two stop blocks, and the distance is less than a width of the to-be-printed panel.

3. The inkjet printing device according to claim 1, wherein the frame is provided with an idle zone, and the idle zone is provided on a side of the processing zone; the moving mechanism is configured to drive the inkjet assembly to reciprocate linearly above the processing zone and the idle zone; and the inkjet assembly is provided in the idle zone in response to a case that the inkjet assembly is not in operation.

4. The inkjet printing device according to claim 3, wherein the frame is provided with an ink receiving portion, and the ink receiving portion is provided below the idle zone; two sides of the ink receiving portion are configured to be trapezoidal; a splash-proof strip is provided at an opening of the ink receiving portion; and an area of the opening of the ink receiving portion is greater than an area of the idle zone.

5. The inkjet printing device according to claim 1, wherein the conveying mechanism further comprises a support strip provided within the transmission belt; and the support strip is configured to support a panel-receiving surface of the transmission belt.

6. The inkjet printing device according to claim 1, wherein the moving mechanism comprises an X-axis slide rail, a second driving part, a Y-axis slide rail, a third driving part, a Z-axis slide rail and a fourth driving part;
two sides of the frame are each provided with the X-axis slide rail;
the Z-axis slide rail is slidably mounted on the X-axis slide rail; and the second driving part is configured to drive the Z-axis slide rail to move along an X-axis direction;
the Y-axis slide rail is slidably mounted on the Z-axis slide rail; and the fourth driving part is configured to drive the Y-axis slide rail to move along a Z-axis direction; and
the inkjet assembly is slidably mounted on the Y-axis slide rail; and the third driving part is configured to drive the inkjet assembly to move along a Y-axis direction.

7. The inkjet printing device according to claim 1, wherein the inkjet assembly comprises a first inkjet head and a first ink cartridge; the first ink cartridge is mounted on an outer side of the frame; and the first inkjet head is configured to draw the ink material from the first ink cartridge through a first suction pump and spray the ink material onto the to-be-printed panel.

8. The inkjet printing device according to claim 7, wherein the inkjet assembly further comprises a second inkjet head and a second ink cartridge; and the second inkjet head is configured to draw the ink material from the second ink cartridge through a second suction pump and spray the ink material onto the to-be-printed panel.

9. The inkjet printing device according to claim 6, wherein the frame is provided with a plurality of horizontal beams and a plurality of vertical beams; and the plurality of horizontal beams and the plurality of vertical beams are provided at a bottom of an overall structure of the X-axis slide rail, the Y-axis slide rail and the Z-axis slide rail, so as to support the conveying mechanism, the inkjet assembly and the moving mechanism.

10. The inkjet printing device according to claim 9, wherein the frame further comprises two fixing slots; one of the two fixing slots is connected to one of the plurality of vertical beams at the bottom of the X-axis slide rail, and the other of the two fixing slots is connected to the Z-axis slide rail; and the two fixing slots are each provided with a drag chain slot fitting a corresponding one of the two fixing slots.
